(19) United States
(12) Patent Application Publication
(10) Pub. No.: US 2025/0253538 A1
(43) Pub. Date: Aug. 7, 2025

(54) CONTROLLING A DIRECTIONAL TRANSMISSION BEAM TO COUNTERACT ANTENNA MOVEMENT

(71) Applicants: Ceragon Networks Ltd., Rosh HaAyin (IL); Ariel Scientific Innovations Ltd., Ariel (IL)

(72) Inventors: Ariel ETINGER, Ariel (IL); Artem GAYZLER, Ramat Gan (IL); David ROTSHILD, Karney Shomron (IL); Efi RAHAMIM, Kiryat Gat (IL)

(73) Assignees: Ceragon Networks Ltd., Rosh HaAyin (IL); Ariel Scientific Innovations Ltd., Ariel (IL)

(21) Appl. No.: 18/854,561

(22) PCT Filed: Apr. 10, 2023
(86) PCT No.: PCT/IL2023/050385

§ 371 Date: Oct. 7, 2024

Related U.S. Application Data
(60) Provisional application No. 63/330,357, filed on Apr. 13, 2022.

(51) Int. Cl. H01Q 15/14; H01Q 15/00; H01Q 19/19

(52) U.S. Cl. CPC H01Q 15/148; H01Q 15/0086; H01Q 19/19

(57) ABSTRACT

A system for counteracting antenna movement in a directional antenna, including a feed horn for providing an electromagnetic signal, a sub-reflector for controlling a direction of reflection of the electromagnetic signal provided by the feed horn, and a main reflector for reflecting the electromagnetic signal arriving from the sub-reflector and transmitting the electromagnetic signal reflected from the main reflector, wherein the sub-reflector includes a metasurface controllable to alter the direction of reflection of the electromagnetic signal by coordinated changes of phase over the sub-reflector surface. A sub-reflector for an antenna, the sub-reflector including a metasurface, wherein the metasurface is controllable to alter a direction of reflection of an electromagnetic signal by coordinated changes of phase over the sub-reflector surface. Related apparatus and methods are also described.

### RELATED APPLICATION

This application is a PCT application claiming priority from U.S. Provisional Patent Application No. 63/330,357 filed on 13 Apr. 2022. The contents of the above application is incorporated by reference as if fully set forth herein.

### FIELD AND BACKGROUND OF THE INVENTION

The present invention, in some embodiments thereof, relates to a system and method for using a dynamically controlled sub-reflector to counteract antenna movement.

Antennas mounted on masts or poles may suffer from vibration, caused, for example, by wind.

In urban installation, and in dense urban installation, there is a tendency to mount antennas on thinner poles or masts than in open areas.

Thinner poles tend to suffer more from vibration.

When a directional antenna on a transmitting side is vibrated, a transmission is made which is not correctly aimed at a receiving antenna, and when a directional antenna on a receiving side is vibrated, reception suffers from incorrect aiming of the receiving antenna. Both cases may decrease link throughput between the antennas.

Background art includes:
An article by Rashid Kalimulin, Alexey Artemenko, Roman Maslennikov, Jyri Putkonen, and Juha Salmelin titled “Impact of Mounting Structures Twists and Sways on Point-to-Point Millimeter-Wave Backhaul Links”, published in 2015 IEEE International Conference on Communication Workshop (ICCW), DOI: 10.1109/ICC31333.2015
An article by E. Rahamim, D. Rotshild, and A. Abramovich, titled “Performance Enhancement of Reconfigurable Metamaterial Reflector Antenna by Decreasing the Absorption of the Reflected Beam”, published in Appl. Sci. 2021, 11, 8999. www(dot)doi(dot)org/10.3390/app11198,999.2.679, 0.
An article by David Rotshild and Amir Abramovich, titled “Realization and validation of continuous tunable metasurface for high resolution beam steering reflector at K-band frequency”, published in Int J RF Microw Comput Aided Eng, 2021, DOI: 10.1002/mmce.22559. 1.694, 5.
An article by D. Rotshild and A. Abramovich, titled “Ultra-Wideband Reconfigurable X-Band and Ku-Band Metasurface Beam-Steerable Reflector for Satellite Communications”, published in Electronics 2021, 10, 2165 www(dot)doi(dot)org/10.3390/electronics 10172165.
An article by David Rotshild, Efi Rahamim and Amir Abramovich, titled “Innovative reconfigurable metasurface 2-D Beam-Steerable reflector for 5G wireless communication”, published in Electronics 2020, 9, 1191; doi: 10.3390/electronics9081191. 2.379, 5.
An article by D. Rotshild and A. Abramovich, titled “Wideband reconfigurable entire Ku band metasurface Beam-Steerable reflector for satellite communications”, published in IET Microwaves, Antennas & Propagation, Vol 13, 3 pp. 334-339, 1.739; 0.

The disclosures of all references mentioned above and throughout the present specification, as well as the disclosures of all references mentioned in those references, are hereby incorporated herein by reference.

### SUMMARY OF THE INVENTION

The present invention, in some embodiments thereof, relates to a system and method for controlling a direction of broadcast of an antenna by controlling reflection from a metasurface on the sub-reflector to counteract antenna movement.

According to an aspect of some embodiments of the present disclosure there is provided a system for counteracting antenna movement in a directional antenna, including a feed horn for providing an electromagnetic signal, a sub-reflector for controlling a direction of reflection of the electromagnetic signal provided by the feed horn, and a main reflector for reflecting the electromagnetic signal arriving from the sub-reflector and transmitting the electromagnetic signal reflected from the main reflector, wherein the sub-reflector includes a metasurface controllable to alter the direction of reflection of the electromagnetic signal by coordinated changes of phase over the sub-reflector surface.

According to some embodiments of the disclosure, the sub-reflector includes a plurality of controllable phase-controlling cells on the reflecting surface of the sub-reflector to change phase differently in different areas of the sub-reflector.

According to some embodiments of the disclosure, the coordinated changes of phase are performed by coordinated changes of capacitance of the controllable phase-changing cells.

According to some embodiments of the disclosure, including a controller for controlling phase change of the electromagnetic signal reflected from the sub-reflector differentially and in coordinated manner.

According to some embodiments of the disclosure, the controller includes an input for accepting a signal based on movement of the main reflector and output for controlling the direction of reflection of the electromagnetic signal so as to counteract the movement.

According to some embodiments of the disclosure, including a gyro component to provide the signal based on the movement of the main reflector.

According to some embodiments of the disclosure, the gyro component is attached to an antenna support component supporting the main reflector.

According to some embodiments of the disclosure, the gyro component is attached to the main reflector.

According to some embodiments of the disclosure, the gyro component is attached to the sub-reflector.

According to some embodiments of the disclosure, the system is configured to receive data related to quality of reception from a receiving antenna and uses the data to control the direction of reflection of the electromagnetic signal.

According to some embodiments of the disclosure, the main reflector is a parabolic reflector.

According to some embodiments of the disclosure, the metasurface is planar.

According to some embodiments of the disclosure, the metasurface is convex.

According to some embodiments of the disclosure, the sub-reflector controls phase of the electromagnetic signal using a voltage applied to varactor diodes of the metasurface cells.

According to an aspect of some embodiments of the present disclosure there is provided a method for counteracting antenna movement in a directional antenna, including providing an electromagnetic signal to a sub-reflector, measuring movement of the antenna, controlling a direction of reflection of the electromagnetic signal from the sub-reflector, and reflecting the electromagnetic signal arriving from the sub-reflector to a specific direction, wherein the controlling the direction of reflection of the electromagnetic signal from the sub-reflector is based on the measured movement.

According to some embodiments of the disclosure, the controlling the reflection direction of the electromagnetic signal includes controlling a phase of the electromagnetic signal reflected from the sub-reflector.

According to some embodiments of the disclosure, the controlling a phase of the electromagnetic signal includes coordinated controlling of metasurface cells on a metasurface on the sub-reflector.

According to some embodiments of the disclosure, the controlling of metasurface cells includes altering capacitance of the metasurface cells.

According to some embodiments of the disclosure, the altering capacitance of the metasurface cells includes applying reverse DC bias to a varactor in the metasurface cells.

According to some embodiments of the disclosure, the measuring movement of the antenna includes using a gyroscope to measure the movement.

According to some embodiments of the disclosure, the controlling the direction of reflection of the electromagnetic signal from the sub-reflector includes calculating an antenna direction offset caused by antenna movement and controlling the direction of reflection of the electromagnetic signal from the sub-reflector to reduce the antenna direction offset.

According to an aspect of some embodiments of the present disclosure there is provided a sub-reflector for an antenna, the sub-reflector including a metasurface, wherein the metasurface is controllable to alter a direction of reflection of an electromagnetic signal by coordinated changes of phase over the sub-reflector surface.

According to some embodiments of the disclosure, the sub-reflector includes a plurality of controllable phase-controlling cells on the reflecting surface of the sub-reflector to change phase differently in different areas of the sub-reflector.

According to some embodiments of the disclosure, the antenna is a directional antenna.

According to some embodiments of the disclosure, the antenna is a parabolic antenna.

According to an aspect of some embodiments of the present disclosure there is provided an antenna including a sub-reflector, wherein the sub-reflector includes a metasurface, wherein the metasurface is controllable to alter a direction of reflection of an electromagnetic signal by coordinated changes of phase over the sub-reflector surface.

According to an aspect of some embodiments of the present disclosure there is provided a method for calibrating a directional antenna including setting up a first, transmitting directional antenna to transmit in a first, initial direction, setting up a second, receiving antenna to receive the transmission of the first antenna, vibrating the first antenna, thereby scanning the transmitting direction of the first antenna at a plurality of different directions around the first initial direction, recording reception power received at the second, receiving antenna at the plurality of different directions around the first initial direction, and recording gyroscope readings from a gyroscope attached to the first, transmitting directional antenna.

According to some embodiments of the disclosure, further including translating gyroscope readings to a transmission direction, and producing a mapping relating the transmission direction to the reception power.

According to some embodiments of the disclosure, further including producing a mapping relating the gyroscope readings to the reception power.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

As will be appreciated by one skilled in the art, some embodiments of the present invention may be embodied as a system, method or computer program product. Accordingly, some embodiments of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, some embodiments of the present invention 15 may take the form of a computer program product embodied in one or more computer readable medium(s) having computer readable program code embodied thereon. Implementation of the method and/or system of some embodiments of the invention can involve performing and/or completing selected tasks manually, automatically, or a combination thereof. Moreover, according to actual instrumentation and equipment of some embodiments of the method and/or system of the invention, several selected tasks could be implemented by hardware, by software or by firmware and/or by a combination thereof, e.g., using an operating system.

For example, hardware for performing selected tasks according to some embodiments of the invention could be implemented as a chip or a circuit. As software, selected tasks according to some embodiments of the invention could be implemented as a plurality of software instructions being executed by a computer using any suitable operating system. In an exemplary embodiment of the invention, one or more tasks according to some exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

Any combination of one or more computer readable medium(s) may be utilized for some embodiments of the invention. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium and/or data used thereby may be transmitted using any appropriate medium, including but not limited to wireless, wireline, optical fiber cable, RF, etc., or any suitable combination of the foregoing.

Computer program code for carrying out operations for some embodiments of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Some embodiments of the present invention may be described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Some of the methods described herein are generally designed only for use by a computer, and may not be feasible or practical for performing purely manually, by a human expert. A human expert who wanted to manually perform similar tasks, such as controlling a broadcast beam antenna to counteract broadcast beam vibration, might be expected to use completely different methods, e.g., making use of expert knowledge, if such a feat is doable by a human, which would be vastly more efficient than manually going through the steps of the methods described herein.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a simplified illustration of a prior art point-to-point antenna link;

FIG. 2 is a prior art graph showing spread of broadcast beam power for various installations when a pole or mast are caused to sway or twist;

FIG. 3 is a simplified illustration of an antenna with a reflector and a controllable metasurface sub-reflector according an example embodiment;

FIG. 4 is a graph showing example signal paths in a parabolic reflector plus sub-reflector arrangement, with and without signal re-direction, according to an example embodiment;

FIG. 5 is a simplified illustration of a controllable phase-changing cell according to an example embodiment;

FIG. 6A is a simplified illustration of an array of controllable phase-changing cells of a metasurface according to an example embodiment;

FIG. 6B is a simplified illustration of controllable phase-changing cells showing how different cells produce different phase changes according to an example embodiment;

FIG. 7A is a graph showing a relation of phase change to capacitance of a controllable phase-changing cell according to an example embodiment;

FIG. 7B is a graph showing a relation of applied voltage to capacitance of a controllable phase-changing cell according to an example embodiment;

FIG. 8 is a simplified flow chart illustration of a method for counteracting antenna movement in a directional antenna according to an example embodiment; and

FIG. 9 is a simplified flow chart illustration of a method for calibrating a directional antenna according to an example embodiment.

### DESCRIPTION OF SPECIFIC EMBODIMENTS OF THE INVENTION

The present invention, in some embodiments thereof, relates to a system and method for using a dynamically controlled sub-reflector to counteract antenna movement and, more particularly, but not exclusively, to a system and method for controlling a metasurface on the sub-reflector to counteract antenna movement.

The term metasurface, is used throughout the present specification and claims to mean a surface which can adjust phase of a reflected wave differently at different locations of the surface, thereby adjusting a direction of reflection of the reflected wave.

In some embodiments, movement of a directional antenna is sensed, and based on the sensing, a metasurface affecting wave reflection is controlled to maintain the directional antenna broadcast direction, counteracting movement of the antenna.

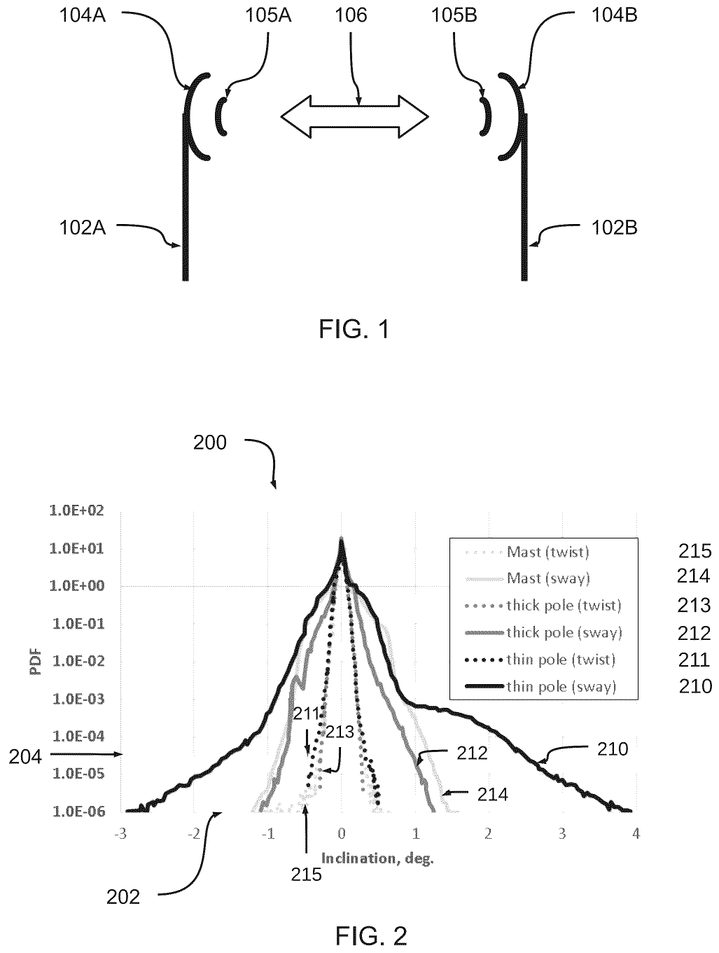

For purposes of better understanding some embodiments of the present invention reference is first made to the construction and operation of a point-to-point wireless link as illustrated in FIG. 1, which is a simplified illustration of a prior art point-to-point antenna link.

FIG. 1 shows a first directional reflector antenna 104A which includes a first sub-reflector 105A on a first mast 102A, aimed toward a second directional reflector antenna 104B which includes a second sub-reflector 105B on a second mast 102B, and the two antennas 104A 104B transmitting and receiving wireless communications 106.

### Introduction

It is desirable for as much of the transmitted energy transmitted by a transmitting antenna to be absorbed by a receiving antenna. This may provide various benefits, such as, by way of some non-limiting examples, potentially increasing an amount of data, which can be transmitted between the antennas; potentially reducing waste energy; potentially reducing errors in communications; and potentially reducing a need to retransmit data.

The term “antenna support” in all its grammatical forms is used throughout the present specification and claims interchangeably with the term “mast” and its corresponding grammatical forms and with the term “pole” and its corresponding grammatical forms.

In recent times some point-to-point transmissions use shorter wavelengths than were used historically, by way of a non-limiting example to support 5G communications. The shorter wavelengths sometimes produce narrower broadcast beams, which suffer more from vibration of directional antennas. The shorter wavelengths sometimes use smaller dishes—directional reflectors—which may be mounted on thinner poles or masts.

The above description may explain a growing need for controlling an antenna broadcast direction to counteract antenna movement.

When a directional antenna on a transmitting side is vibrated, a transmission is made which is not correctly aimed at a receiving antenna, and when a directional antenna on a receiving side is vibrated, reception suffers from incorrect aiming of the receiving antenna. Both cases may decrease link throughput between the antennas.

A non-limiting example of a transmission beam width may be approximately 2-3 degrees. Mounting a directional antenna on a pole or mast which twists or sways or somehow shifts direction of the beam by an amount equivalent to the beam width, or even less than the beam width, can cause significant deterioration of a received signal.

### Overview

An aspect of some embodiments relates to enabling a directional antenna, such as, by way of a non-limiting example, a parabolic antenna, to control a transmission beam direction by controlling phase of electromagnetic waves reflected by a sub-reflector component of the antenna.

The directional antenna is aimed at a specific direction, typically at a receiving antenna. If wind or other sources affect the antenna, causing it to vibrate, the beam direction is optionally corrected so as to remain directed in the same specific direction, or at least to remain closer to the specific direction than if not corrected.

In some embodiments, a vibration sensor and/or a direction sensor, by way of a non-limiting example a gyroscope, provides data regarding movement of the antenna, optionally at a frequency which is higher than a vibration movement.

Data about the movement is optionally used to control the direction that the antenna is broadcasting, adjusting it to be near the specific direction, correcting for movement of the antenna.

Adjusting the phase at which a wave is reflected from a surface can adjust a direction of reflection from the surface, as the direction of reflection is determined by a direction normal to the wave front.

In some embodiments, the receiving antenna optionally transmits data about amplitude and/or quality of a received transmission, optionally at an update rate which is higher than a vibration movement, potentially enabling controlling the direction of broadcast to improve quality and/or increase amplitude of reception.

In some embodiments, the sub-reflector is located at, or approximately at, a location of a focus of a main parabolic reflector antenna.

In some embodiments, the controlling the phase of the electromagnetic waves is by controlling a metasurface on the sub-reflector, to control direction of reflection of a reflected wave.

A metasurface modulates behavior of electromagnetic waves. Metasurfaces may also refer to the two-dimensional surfaces constructed by metamaterial cells. A metamaterial is a periodic, electronic, typically printed structure.

In some embodiments, a metasurface (MS) causes a phase shift of electromagnetic radiation reflected from the metasurface.

In some embodiments, a metasurface includes a surface including several, even many, controllable phase-changing cells, where different cells cause different, controlled, phase shifts of electromagnetic radiation reflected from the metasurface.

In some embodiments, the phase shift is optionally controlled by controlling an electric voltage.

In some embodiments, Varactor diodes are used to change capacitance of unit cells of the MS, the change in capacitance, changes a phase shift effected by the unit cell on reflected electromagnetic radiation as a function of applied DC voltage. When different cells act on a wave front, changing the phase of the wave front differently at different locations, the combined effect is optionally controlled to control a direction of the reflected wave-front.

The change in phase of reflected electromagnetic radiation of unit cells controls a direction of an electromagnetic beam reflected off the metasurface.

In some embodiments, the control is by an electronic circuit converting a measured direction deviation signal to an appropriate phase change to each unit cell in a metasurface on a sub-reflector.

In some embodiments, the electronic circuit is mounted on the sub-reflector.

In some embodiments, a component for measuring a direction deviation is mounted on the sub-reflector. In some embodiments, a component for measuring a direction deviation is mounted on the main reflector of the directional antenna. In some embodiments, a component for measuring a direction deviation is mounted on a mast or pole to which the directional antenna is attached.

An aspect of some embodiments relates to controlling a transmission direction of a directional antenna. The directional antenna is aimed in some initial direction, a deviation from the initial direction is measured over time, and in case of deviation from the initial direction, the transmission direction is corrected back to the initial direction, or at least back closer to the initial direction.

In some embodiments, directional deviation is measured by a gyroscope attached to a sub-reflector of the directional antenna, potentially enabling measuring movement and controlling beam direction to be performed by a control unit attached to the sub-reflector.

In some embodiments, the gyroscope provides one or more of a direction of deviation from an initial direction; an amount of deviation; or an angle of deviation.

In some embodiments, directional deviation is measured by a gyroscope attached to a main directional antenna, such as a main parabolic reflector.

In some embodiments, directional deviation is measured by a gyroscope attached to a pole or mast to which the main directional antenna is attached.

In some embodiments, the pole or the mast or the directional antenna are intentionally vibrated, and a mapping of mechanical antenna deviation as measured by the gyroscope to the received transmission power and/or quality is produced. Such a mapping potentially enables calibrating direction adjustment of directional antenna broadcast based on received transmission power, in systems where the received transmission power and/or quality are transmitted back to the broadcast transmitter.

In some embodiments, the mapping is used to steer beam direction so that the beam direction remains approximately constant, by controlling the beam direction to cancel the antenna movement.

The term gyroscope is used herein to include various types of motion tracking devices, in some embodiments tracking motion in 1, 2 or 3 axes.

In some embodiments, the motion tracking devices is optionally a component designed to be placed on a printed circuit board (PCB).

A non-limiting example of a packaged integrated motion tracking device that combines a 3 axis gyroscope and a communication interface (I2C, SPI etc.) is an MPU-6000.

In some embodiments, a response time of the metasurface to produce a desired direction deviation can be on the order of 1 nano-second, which is relatively fast compared to pole or mast vibrations, potentially enabling to maintain a steady transmission direction even when vibrations are at a rate above 1 KHz and above 1 MHz, up to hundreds of Megahertz.

In some embodiments, a resonance frequency of mast vibration may be either measured or calculated, and metasurface direction correction may optionally be applied to adjust transmission direction based on that frequency.

An aspect of some embodiments relates to controlling the aiming direction of the directional antenna based on measuring received power at a receiver, and having the receiver transmit data about the received power back to the directional transmitter. The directional transmitter optionally controls an aiming direction of a beam direction to increase received power.

Since measuring received power and transmitting it back to the transmitter can be performed rapidly, for example within less than a millisecond, or even a microsecond, controlling direction of the transmitting antenna can compensate for mechanical vibration of the transmitting antenna at a frequency of 10 Hz, 100 Hz or even up to 1,000 Hz or more, based on receiving feedback data about received power from the receiving antenna. The capability of controlling direction as described herein exceeds frequencies which are expected to be typical mechanical vibration frequencies of a transmitting antenna. The response time of steering transmission direction by using a metasurface can be an order of magnitude more rapid than the mechanical vibration of a mast or pole.

In some embodiments, controlling the aiming direction of a beam direction to increase received power is optionally based on receiving data about reception power, analyzing the data to detect a frequency at which the received power fluctuates, and controlling the transmission direction to fluctuate in direction at that frequency, to compensate for the mechanical vibration of the transmitting antenna.

In some embodiments, a resonance frequency of mast vibration may be either measured or calculated, and metasurface direction correction may optionally be applied to adjust transmission direction based on that frequency.

An aspect of some embodiments relates to electronically controlling a direction of reflectance of an electromagnetic wave from a metasurface.

In some embodiments, the metasurface is an array of cells, each cell designed to control a phase of an electromagnetic wave reflected from the cell.

In some embodiments, the reflected electromagnetic phase change is controlled/coordinated among the cells to produce a wave-front of the reflected electromagnetic wave in a desired direction.

In some embodiments, the phase change caused by a unit cell is controlled by adjusting a capacitance of a unit cell of the metasurface.

In some embodiments, adjusting a capacitance of a unit cell of the metasurface is by applying an adjustable voltage to a voltage controlled capacitor, by way of a non-limited example a varactor or varactor diode.

An aspect of some embodiments relates to calculating an effect of voltage applied to a voltage controlled capacitor on a phase change of an electromagnetic wave reflected from a unit cell of a metasurface which includes the voltage controlled capacitor.

In some embodiments, a Look Up Table (LUT) converting applied voltage to phase change, or desired phase change to applied voltage, is optionally produced from data or graphs describing:
the effect of voltage on capacitance of the voltage controlled capacitor. By way of a non-limiting example taking such data may be taken from a datasheet describing the voltage controlled capacitor, or such data may be produced by measuring capacitance and voltage on the voltage controlled capacitor; and
the effect of capacitance on phase change of a reflected electromagnetic wave from the voltage controlled capacitor. By way of a non-limiting example taking such data may be produced by measuring capacitance and/or voltage and a phase change of the reflected electromagnetic wave or a direction of reflectance of the electromagnetic wave.

Before explaining at least one embodiment of the invention in detail, it is to be understood that the invention is not necessarily limited in its application to the details of construction and the arrangement of the components and/or methods set forth in the following description and/or illustrated in the drawings. The invention is capable of other embodiments or of being practiced or carried out in various ways.

Reference is now made to FIG. 2, which is a prior art graph showing spread of broadcast beam power for various installations when a pole or mast are caused to sway or twist.

The data presented in the graph is taken from the above-mentioned publication titled “Impact of Mounting Structures Twists and Sways on Point-to-Point Millimeter-Wave Backhaul Links”, where measurements were made using a 3D deflection meter.

FIG. 2 is brought to show an effect of pole or mast movement from a central direction that leads to degradation of a received signal.

FIG. 2 shows a graph 200 with an X-axis 202 showing deviation in degrees from a central direction considered to be at 0 degrees, and a Y-axis showing value of a PDF (Probability Distribution Function) of a transmitted signal beam. The deviation measurements were done by a 3D deflection meter.

FIG. 2 shows:
a first line 210 showing beam spread when a thin pole carrying the antenna is caused to sway;
a second line 211 showing beam spread when the thin pole is caused to twist;
a third line 212 showing beam spread when a thick pole carrying the antenna is caused to sway;
a fourth line 213 showing beam spread when the thick pole is caused to twist;
a fifth line 214 showing beam spread when a mast carrying the antenna is caused to sway; and
a sixth line 215 showing beam spread when the mast is caused to twist.

FIG. 2 compares thicknesses of poles/masts, showing that thin poles, such as are likely to be used in urban settings, are more prone to beam spread under movement of the poles/masts.

The above-mentioned publication describes what is termed a mast, what a thick pole is and what a thin pole is.

The above-mentioned publication also describes twist as a rotation angle around a vertical axis of the pole/mast and sway as an inclination angle relative to the axis of pole/mast.

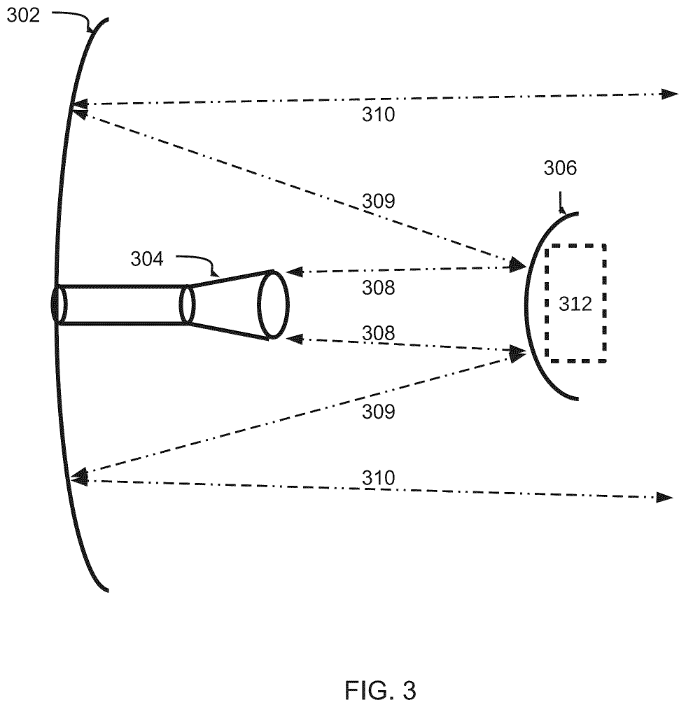

Reference is now made to FIG. 3, which is a simplified illustration of an antenna with a reflector and a controllable metasurface sub-reflector according to an example embodiment.

FIG. 3 is intended to show one example embodiment of how a directional antenna can be assembled together with a controllable sub-reflector to aim a transmitted signal beam to compensate for antenna movement.

FIG. 3 shows a direction antenna 302, by way of a non-limiting example a parabolic antenna 302, a feed horn 304 through which a feed signal 308 is transmitted toward a sub-reflector 306, the feed signal 308 reflected as a reflected signal 309 off the sub-reflector, and the reflected signal 308 reflected yet again as a transmission signal 310 off the antenna 302, to a desired direction.

It is noted that the signals 308 309 310 may also pass in a reverse direction through the arrangement shown in FIG. 3, acting as a receiving antenna.

In some embodiments, the sub-reflector 306 includes an electronically controllable phase-changing metasurface.

In some embodiments, different locations on the sub-reflector 306 are optionally controlled to change the reflected signal phase differently, there affecting a direction of a wave-front of the signal reflected from the sub-reflector 306, thereby affecting a direction of the signal 310.

In some embodiments, a controller 312 for controlling phase shifting of different portions of the area of the sub-reflector 306 is optionally mounted on the sub-reflector 306.

In some embodiments, the controller controls many, tens or even hundreds or thousands of separately controllable metasurface cells located on the sub-reflector 306, and may perform the controlling via many, tens or even hundreds or thousands of conductors.

In some embodiments, the controller may be placed close to the metasurface of the sub-reflector, to reduce a length of the many conductors.

In some embodiments, the controller coordinates the phase change caused by each cell, so that the phase change causes a change in the reflected wave-front.

In some embodiments, the controller 312 controls a number, even a large number, of metasurface elements or cells, and it may be advantageous to have the controller 312 close to the metasurface on the sub-reflector 306, to reduce a distance that a large number of electrical wires corresponding to the metasurface cells need to be extended.

In some embodiments, the controller 312 is optionally mounted elsewhere, such as on the reflector 302, or on a mast or pole on which the reflector 302 is mounted.

In some embodiments, the controller 312 may optionally communicate by wireless communications or Bluetooth with an additional component (not shown) which controls a metasurface cell.

In some embodiments, a metasurface cell includes a phase shift component. In some embodiments, the metasurface is constructed of many cells, each one of which is controllable to provide a controllable amount of phase shift to an electromagnetic wave reflected from the cell. By controlling different phase shifts at different locations, one controls a direction of a wave-front of the electromagnetic wave reflected from the metasurface, thereby controlling a direction that the electromagnetic wave is reflected by the metasurface.

In some embodiments, each unit cell includes a varactor diode that changes the diode's junction capacitance as function of reverse DC bias voltage connected to its leads. In such an example embodiment, the controller optionally includes a series of DACs (Digital to Analog Converters) connected to the leads, controlling the junction capacitance of each varactor diode, the junction capacitance controls the phase shift of a reflected electromagnetic wave, and a combined effect of unit cells on the reflected electromagnetic wave controls a direction of a wave-front of the reflected electromagnetic wave and the beam direction.

A reflected electromagnetic wave depends on a reflecting surface or structure. Changing the diode capacitance, such as a P-N junction capacitance of a varactor diode, changes the electronic behavior of the structure, thus changing a phase of a reflected electromagnetic wave.

In some embodiments, a series of programmable DACs control the reverse DC bias of each varactor diode of the metasurface.

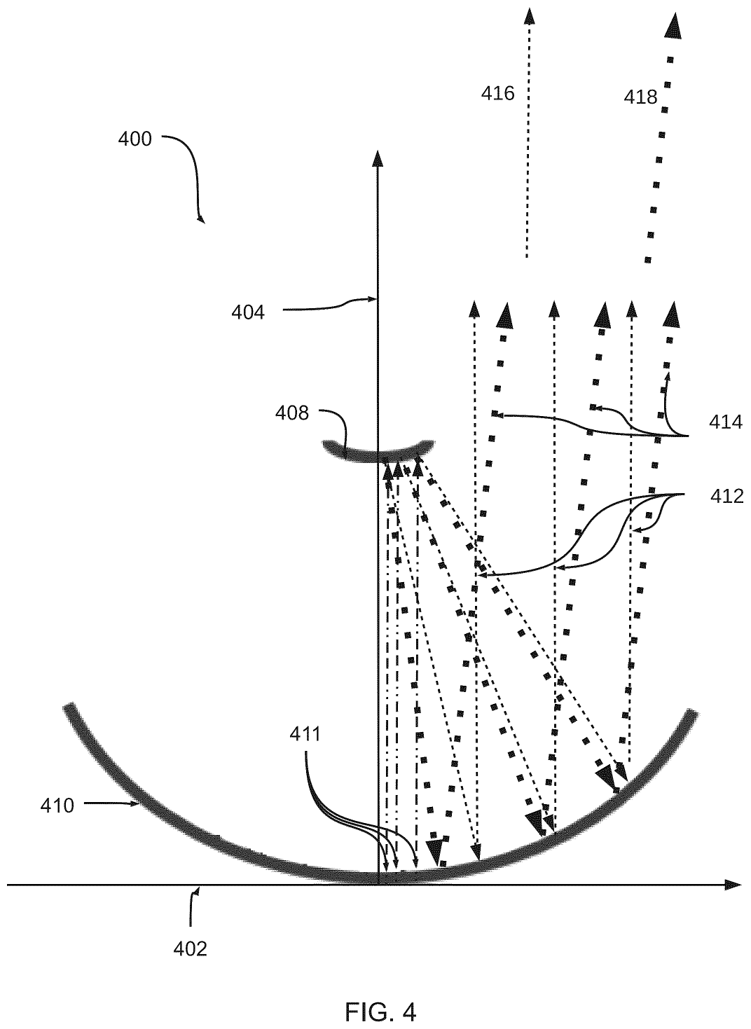

Reference is now made to FIG. 4, which is a graph showing example signal paths in a parabolic reflector plus sub-reflector arrangement, with and without signal re-direction, according to an example embodiment.

FIG. 4 is intended to show how a sub-reflector changes direction of a transmitted beam by changing direction of signals reflected off the sub-reflector.

FIG. 4 shows a graph 400 with an X-axis 402 showing an offset from center of an example parabolic reflector 410 using arbitrary units, and a Y-axis 404 showing distance along a central axis of the parabolic reflector 410, using arbitrary units.

FIG. 4 also shows a sub-reflector 408, placed centered along the central axis of the reflector 410.

FIG. 4 shows a first set of lines 411 which represent electromagnetic radiation broadcast to the sub-reflector 408, for example parallel to the central 404 of the parabolic reflector 410.

FIG. 4 shows a second set of lines 412 which show paths of electromagnetic radiation in a case where the sub-reflector 408 reflects the electromagnetic radiation according to specular reflection.

A first direction 416 of a central axis of a transmitted beam based on the second set of lines 412 is parallel to the central axis of the parabolic reflector 410.

In some embodiments, the sub-reflector 408 is optionally controlled to change a direction of electromagnetic radiation reflected by the sub-reflector 408, as shown by a third set of lines 414. A second direction 418 of a central axis of a transmitted beam based on the third set of lines 414 is at an angle relative to the central axis of the parabolic reflector 410.

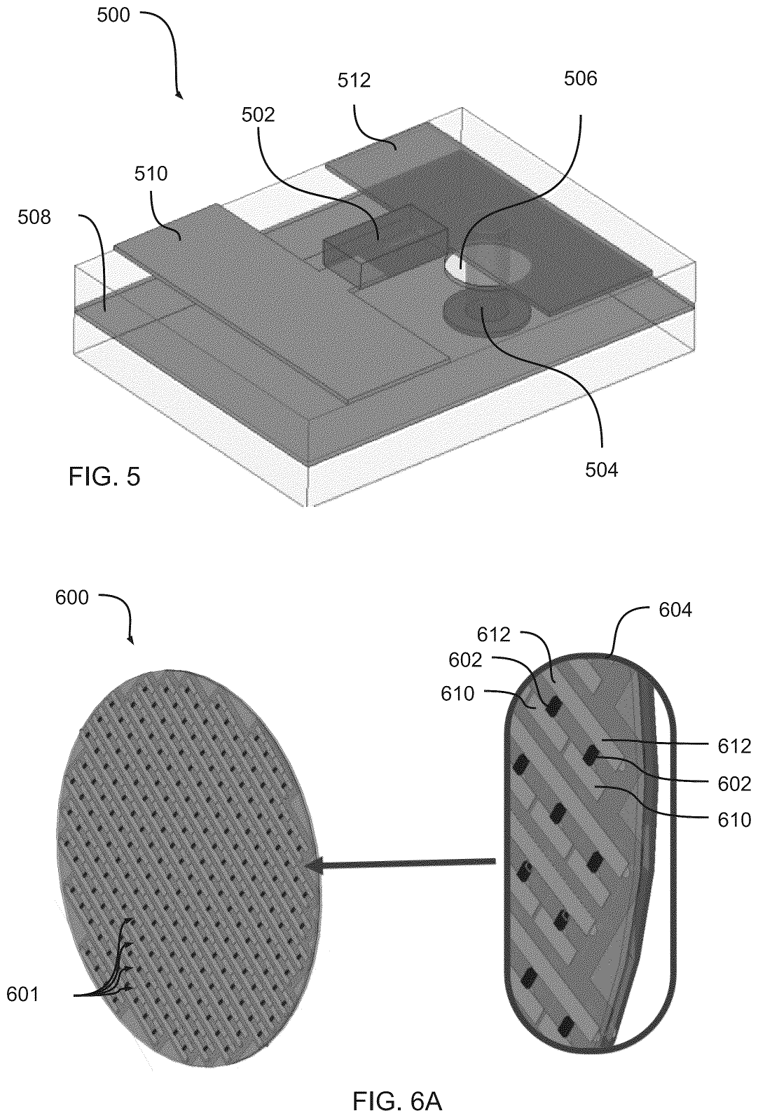

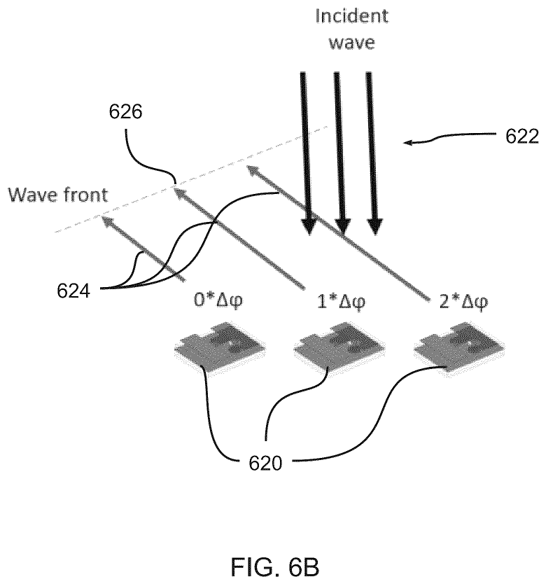

In some embodiments, the sub-reflector 408 is has a reflecting surface made of metamaterial, by way of some non-limiting example as described in FIGS. 5, 6A-B and 7A-B, which can be electronically controlled to reflect an electromagnetic wave at various directions including a direction of specular reflection, as well as directions other than the specular reflection direction.

Reference is now made to FIG. 5, which is a simplified illustration of a controllable phase-changing cell according to an example embodiment.

FIG. 5 shows a controllable phase-changing cell 500, including ground voltage electrode 510 and DC voltage electrode 512, connected on either side of a varactor diode 502. The cell 500 also includes a bottom ground layer 508 and a via 506 that provides a DC voltage bias.

The controllable phase-changing cell 500 can change a phase of an electromagnetic wave-front reflected by the cell depending on voltage applied by a controller (not shown) which supplies a control DC voltage to the cell 500 through a control connection 504. Changing the phase of the electromagnetic differently by many such cells, in a coordinated manner, changes phase of the reflected electromagnetic wave-front differently at different locations, and controls a direction of a reflected wave-front across an area covered by the many cells.

In some embodiments, the controllable phase-changing cell 500 is optionally constructed upon a printed circuit board (PCB) suitable for high frequencies in the microwave and optionally even the millimeter wave frequencies, and/or suitable for frequencies up to 330 GHz.

In some embodiments, the PCB uses a ceramic base as a high-frequency material.

In some embodiments, a PCB produced by Rogers Company, named a Rogers PCB is optionally used.

In some embodiments, a double layer Rogers 5340 board is used.

Reference is now made to FIG. 6A, which is a simplified illustration of an array of controllable phase-changing cells of a metasurface according to an example embodiment.

FIG. 6A shows a non-limiting example embodiment array 600. In the non-limiting example array 600 shown in FIG. 6A, the array is round. However, the array may be any desirable shape, for example rectangular, triangular, polygonal, and so on.

FIG. 6A shows a non-limiting example embodiment array 600. In the non-limiting example array 600 shown in FIG. 6A, the array has an approximately flat surface. However, the array may have other shapes of surfaces such as a concave surface, or a convex surface, which may optionally be selected for use in a sub-reflector.

The array 600 includes controllable phase-changing cells 601 similar to the controllable phase-changing cell 500 shown in FIG. 5.

FIG. 6A shows an enlarged view 604 of a section of the array 600. The enlarged view 604 shows details of example metasurface cells including ground conductor lines 612; DC voltage conductor lines 610; and varactors 602. Control signal conductors corresponding to the control connection 504 of FIG. 5 are on a hidden side of the array 600, not shown in FIG. 6A.

In some embodiments, the ground conductor lines 612 are optionally common to several metasurface cells. In some embodiments, the DC voltage conductor lines 610 are optionally common to several metasurface cells.

Reference is now made to FIG. 6B, which is a simplified illustration of controllable phase-changing cells showing how different cells produce different phase changes according to an example embodiment.

By coordinating/controlling different cells to produce different phase changes in a reflected electromagnetic wave at the locations of the cells, it is possible to control a direction of a wave-front of the reflected electromagnetic wave, and so control a direction of the reflected electromagnetic wave.

FIG. 6B shows controllable metasurface cells 620, optionally as shown in FIGS. 5 and/or 6A, an incident wave 622 impinging upon the cells 620, and a wave-front 626 of the incident wave 622 reflected by the cells 620.

The cells 620 are optionally controlled so that the leftmost cell 620 does not change phase of the incident wave 622 (phase change=0*Δφ), the middle cell 620 changes phase of the incident wave by 1*Δφ, and the rightmost cell 620 changes phase of the incident wave by 2*Δφ, and so on.

As shown by FIG. 6B, changing the phase of the incident wave 622, changes the direction 624 of the reflected wave-front 626.

In some embodiments, the phase is changed differently at each cell by controlling the cells 620 to have different capacitances, the different capacitances being coordinated to produce a desired direction of the wave-front 626 of the incident wave 622 reflected by the cells 620.

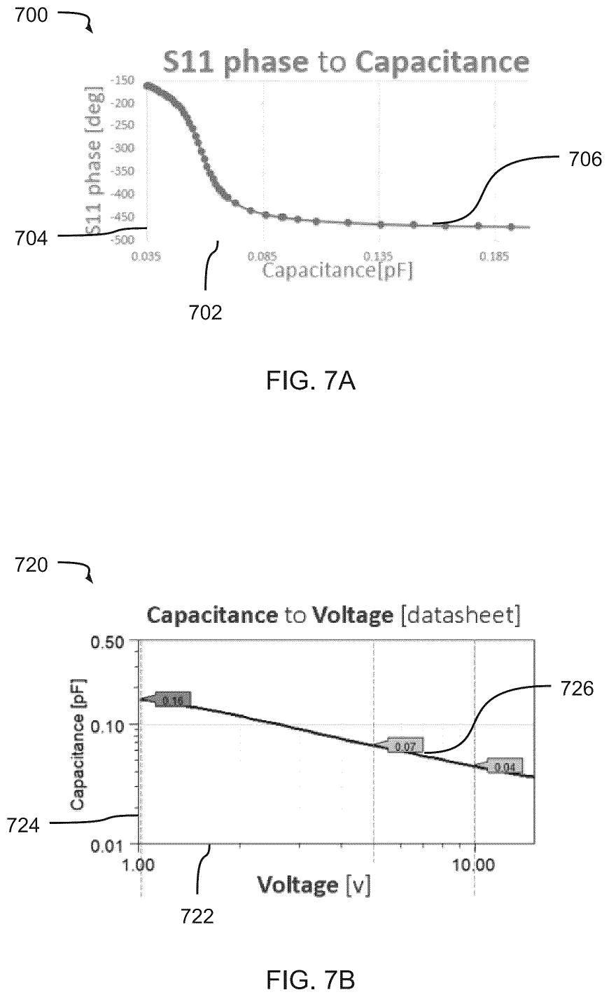

Reference is now made to FIG. 7A, which is a graph showing a relation of phase change to capacitance of a controllable phase-changing cell according to an example embodiment.

FIG. 7A shows a graph 700, having an X-axis 702 in units of capacitance, and a Y-axis 704 in units of phase-change degrees.

A line 706 in the graph shows a non-limiting example of what capacitance of a metasurface cell causes what phase change in a reflected electromagnetic wave.

Reference is now made to FIG. 7B, which is a graph showing a relation of applied voltage to capacitance of a controllable phase-changing cell according to an example embodiment;

FIG. 7B shows a graph 720, having an X-axis 722 in units of voltage applied to a non-limiting example of a metasurface cell, and a Y-axis 704 in units of capacitance of the non-limiting example of the metasurface cell caused by the applied voltage.

A line 726 in the graph shows a non-limiting example of what capacitance of the metasurface cell is produced by what applied voltage.

FIGS. 7A and 7B illustrate a mathematical relationship between voltages applied to a controllable phase-changing cell to phase change in a reflected electromagnetic wave.

In some embodiments, the data illustrated in FIGS. 7A and 7B is optionally combined as a Look Up Table (LUT) enabling looking up a control voltage based on input of a desired phase change.

In some embodiments, the data illustrated in FIGS. 7A and 7B is optionally combined as a mathematical function enabling computing a control voltage based on input of a desired phase change.

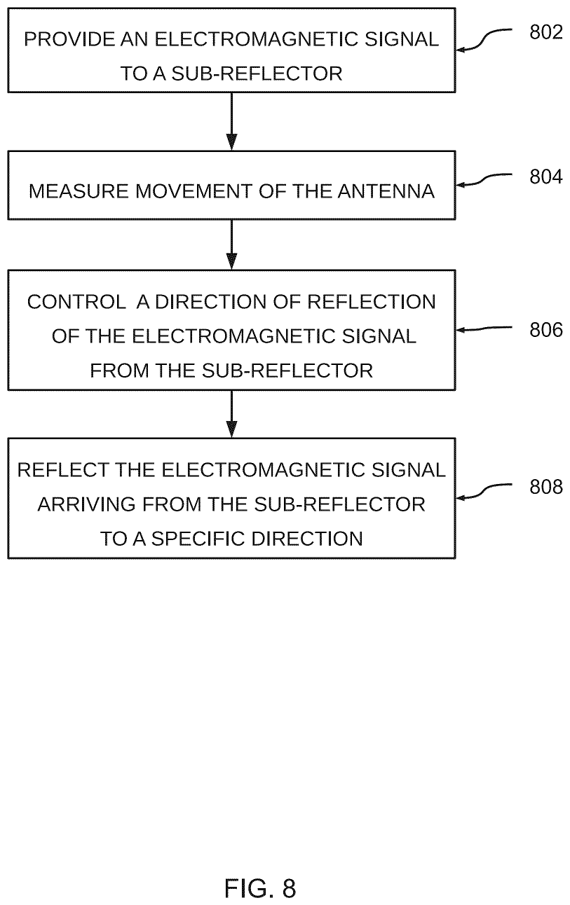

Reference is now made to FIG. 8, which is a simplified flow chart illustration of a method for counteracting antenna movement in a directional antenna according to an example embodiment.

The method of FIG. 8 includes:
providing an electromagnetic signal to a sub-reflector (802);
measuring movement of the antenna (804);
controlling a direction of reflection of the electromagnetic signal from the sub-reflector (806); and
reflecting the electromagnetic signal arriving from the sub-reflector to a specific direction (808).

In some embodiments, the adjusting the direction of reflection of the electromagnetic signal from the sub-reflector is based on the measured movement.

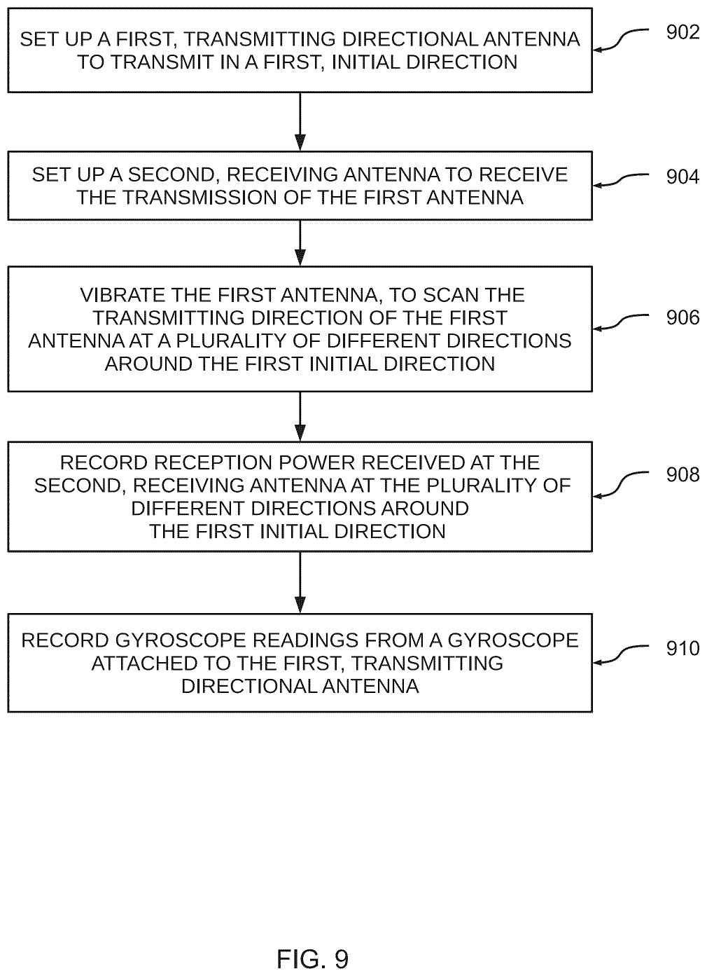

Reference is now made to FIG. 9, which is a simplified flow chart illustration of a method for calibrating a directional antenna according to an example embodiment.

The method of FIG. 9 includes:
setting up a first, transmitting directional antenna to transmit in a first, initial direction (902);
setting up a second, receiving antenna to receive the transmission of the first antenna (904);
vibrating the first antenna, thereby scanning the transmitting direction of the first antenna at a plurality of different directions around the first initial direction (906);
recording reception power received at the second, receiving antenna at the plurality of different directions around the first initial direction (908); and
recording gyroscope readings from a gyroscope attached to the first, transmitting directional antenna (910).

In some embodiments, the gyroscope readings are translated to a transmission direction, and a mapping and/or translation and/or Look Up Table is produced which maps the transmission direction to the reception power.

In some embodiments, a mapping and/or translation and/or Look Up Table is produced which maps the gyroscope readings to the reception power.

It is expected that during the life of a patent maturing from this application many relevant wave reflecting structures and materials will be developed and the scope of the term metasurface (MS) is intended to include all such new technologies a priori.

As used herein with reference to quantity or value, the term “about” means “within ±50% of”

The terms “comprising”, “including”, “having” and their conjugates mean “including but not limited to”.

The term “consisting of” is intended to mean “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a unit” or “at least one unit” may include a plurality of units, including combinations thereof.

The words “example” and “exemplary” are used herein to mean “serving as an example, instance or illustration”. Any embodiment described as an “example or “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein (for example “10-15”, “10 to 15”, or any pair of numbers linked by these another such range indication), it is meant to include any number (fractional or integral) within the indicated range limits, including the range limits, unless the context clearly dictates otherwise. The phrases “range/ranging/ranges between” a first indicate number and a second indicate number and “range/ranging/ranges from” a first indicate number “to”, “up to”, “until” or “through” (or another such range-indicating term) a second indicate number are used herein interchangeably and are meant to include the first and second indicated numbers and all the fractional and integral numbers therebetween.

Unless otherwise indicated, numbers used herein and any number ranges based thereon are approximations within the accuracy of reasonable measurement and rounding errors as understood by persons skilled in the art.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1. A system for counteracting antenna movement in a directional antenna, comprising:
a feed horn for providing an electromagnetic signal;
a sub-reflector for controlling a direction of reflection of the electromagnetic signal provided by the feed horn; and
a main reflector for reflecting the electromagnetic signal arriving from the sub-reflector and transmitting the electromagnetic signal reflected from the main reflector,
wherein the sub-reflector comprises a metasurface controllable to alter the direction of reflection of the electromagnetic signal by coordinated changes of phase over the sub-reflector surface.

2. The system according to claim 1, wherein the sub-reflector comprises a plurality of controllable phase-controlling cells on the reflecting surface of the sub-reflector to change phase differently in different areas of the sub-reflector.

3. The system according to claim 2, wherein the coordinated changes of phase are performed by coordinated changes of capacitance of the controllable phase-changing cells.

4. The system according to claim 1, comprising a controller for controlling phase change of the electromagnetic signal reflected from the sub-reflector differentially and in coordinated manner.

5. The system according to claim 4, wherein the controller comprises an input for accepting a signal based on movement of the main reflector and output for controlling the direction of reflection of the electromagnetic signal so as to counteract the movement.

6. The system according to claim 5, comprising a gyro component to provide the signal based on the movement of the main reflector.

7. The system according to claim 6, wherein the gyro component is attached to an antenna support component supporting the main reflector, or wherein the gyro component is attached to the main reflector, or wherein the gyro component is attached to the sub-reflector.

8-9. (canceled)

10. The system according to claim 1, wherein the system is configured to receive data related to quality of reception from a receiving antenna and uses the data to control the direction of reflection of the electromagnetic signal.

11. The system according to claim 1, wherein the main reflector is a parabolic reflector.

12. The system of claim 1, wherein the metasurface is planar.

13. The system of claim 1, wherein the metasurface is convex.

14. The system according to claim 2, wherein the sub-reflector controls phase of the electromagnetic signal using a voltage applied to varactor diodes of the metasurface cells.

15. A method for counteracting antenna movement in a directional antenna, comprising:
providing an electromagnetic signal to a sub-reflector;
measuring movement of the antenna;
controlling a direction of reflection of the electromagnetic signal from the sub-reflector; and
reflecting the electromagnetic signal arriving from the sub-reflector to a specific direction,
wherein the controlling the direction of reflection of the electromagnetic signal from the sub-reflector is based on the measured movement.

16. The method according to claim 15, wherein the controlling the reflection direction of the electromagnetic signal comprises controlling a phase of the electromagnetic signal reflected from the sub-reflector.

17. The method according to claim 16, wherein the controlling a phase of the electromagnetic signal comprises coordinated controlling of metasurface cells on a metasurface on the sub-reflector.

18. The method according to claim 17, wherein the controlling of metasurface cells comprises altering capacitance of the metasurface cells.

19. The method according to claim 18, wherein the altering capacitance of the metasurface cells comprises applying reverse DC bias to a varactor in the metasurface cells.

20. The method according to claim 15, wherein the measuring movement of the antenna comprises using a gyroscope to measure the movement.

21. The method according to claim 15, wherein the controlling the direction of reflection of the electromagnetic signal from the sub-reflector comprises calculating an antenna direction offset caused by antenna movement and controlling the direction of reflection of the electromagnetic signal from the sub-reflector to reduce the antenna direction offset.

22. The system of claim 1, the sub-reflector comprising a metasurface, wherein the metasurface is controllable to alter a direction of reflection of an electromagnetic signal by coordinated changes of phase over the sub-reflector surface.

23. The system according to claim 22, wherein the sub-reflector comprises a plurality of controllable phase-controlling cells on the reflecting surface of the sub-reflector to change phase differently in different areas of the sub-reflector.

24. The system according to claim 22, wherein the antenna is a directional antenna or a parabolic antenna.

25-26. (canceled)

27. A method for calibrating a directional antenna comprising:
setting up a first, transmitting directional antenna to transmit in a first, initial direction;
setting up a second, receiving antenna to receive the transmission of the first antenna;
vibrating the first antenna, thereby scanning the transmitting direction of the first antenna at a plurality of different directions around the first initial direction;
recording reception power received at the second, receiving antenna at the plurality of different directions around the first initial direction; and
recording gyroscope readings from a gyroscope attached to the first, transmitting directional antenna.

28-29. (canceled)
